(19) United States
(12) Patent Application Publication
(10) Pub. No.: US 2014/0115934 A1
(43) Pub. Date: May 1, 2014

(54) AIR SCOOP

(71) Applicant: George CLAVEY, Waukegan, IL (US)

(72) Inventor: George CLAVEY, Waukegan, IL (US)

(21) Appl. No.: 13/922,435

(22) Filed: Jun. 20, 2013

Related U.S. Application Data
(60) Provisional application No. 61/662,832, filed on Jun. 21, 2012.

(51) Int. Cl. B60K 13/02

(52) U.S. Cl. CPC B60K 13/02
USPC 37/266; 180/68.3

(57) ABSTRACT

According to an aspect of some embodiments of the present invention there is provided a device for directing air flow to at least one engine component of a vehicle carrying a snowplow, the device comprising at least one air inlet; at least one conduit, the conduit in fluid communication with the at least one air inlet; and a connector having at least a first opening in fluid communication with the at least one conduit, the connector having a second opening adapted for fluid communication with the at least one engine component to allow air flow from the at least one air inlet to reach the at least one engine component, the at least one air inlet and the second opening being laterally displaced relative to each other along a short axis of the vehicle.

### RELATED APPLICATION

This application claims the benefit of priority under 35 USC §119(e) of U.S. Provisional Patent Application No. 61/662,832 filed Jun. 21, 2012, the contents of which are incorporated herein by reference in their entirety.

### FIELD AND BACKGROUND OF THE INVENTION

The present invention, in some embodiments thereof, relates to an air flow device and, more particularly, but not exclusively, to an air flow device for directing air flow around a snowplow towards an engine.

U.S. Pat. No. 5,881,479, which states “An apparatus for cooling a radiator of a vehicle carrying a snowplow. The apparatus includes an air flow directing mechanism located adjacent the plow, capable of directing air flow at the radiator when the plow blade is in a riding position.”

### SUMMARY OF THE INVENTION

An aspect of some embodiments of the invention relates to a device and/or method for directing ambient air from around a snowplow to at least one engine component, without significantly interfering with standard operation.

According to an aspect of some embodiments of the present invention there is provided a device for directing air flow to at least one engine component of a vehicle carrying a snowplow, the device comprising at least one air inlet; at least one conduit, the conduit in fluid communication with the at least one air inlet; and a connector having at least a first opening in fluid communication with the at least one conduit, the connector having a second opening adapted for fluid communication with the at least one engine component to allow air flow from the at least one air inlet to reach the at least one engine component, the at least one air inlet and the second opening being laterally displaced relative to each other along a short axis of the vehicle.

According to some embodiments of the invention, the device comprises at least two air inlets and the connector respectively comprises at least two first openings. Optionally, the device is arranged as a ‘Y’, the connector forming the root of the ‘Y’, and the left and right conduits forming the arms of the ‘Y’.

According to some embodiments of the invention, at least a portion of the at least one conduit is made out of a flexible material so that the portion can accommodate changes in position and/or orientation. Optionally, the portion is corrugated.

According to some embodiments of the invention, the two air inlets are spaced apart enough so as not to significantly interfere with headlights on the vehicle, the headlights being located between the two air inlets.

According to some embodiments of the invention, laterally displaced comprises a distance of at least about 30 centimeters.

According to some embodiments of the invention, a total opening area of the air inlets is large enough to provide enough air to the at least one engine component to cool the at least one engine component under standard snow removal operation.

According to some embodiments of the invention, the connector is positioned in front of a grill of the vehicle and the air inlets are positioned above the snowplow.

According to some embodiments of the invention, the second opening is large enough to cover the entire area of a grill of the vehicle.

According to some embodiments of the invention, a snow removal system comprises a device for directing air flow according to claim 1; a snowplow; and a vehicle having at least one engine component, the snowplow being coupled to the vehicle for snow removal, and the device for directing air flow is coupled to the vehicle so that the device directs air to the at least one engine component.

According to an aspect of some embodiments of the present invention there is provided a device for directing air flow to at least one engine component of a vehicle carrying a snowplow, the device comprising at least one air inlet; at least one conduit, the conduit in fluid communication with the at least one air inlet; and a connector having at least a first opening in fluid communication with the at least one conduit, the connector also having a second opening adapted for fluid communication with the at least one engine component to allow air flow from the at least one air inlet to reach the at least one engine component, the opening area of the second opening being larger than the opening area of the at least one air inlet.

According to some embodiments of the invention, larger comprises at least 50% larger.

According to some embodiments of the invention, the opening area of the second opening is large enough to cover an entire grill area of the vehicle.

According to some embodiments of the invention, a portion of the at least one conduit is constructed so that the at least one air inlet can tilt relative to the connector.

According to an aspect of some embodiments of the present invention there is provided a method of delivering air to at least one engine component of a vehicle carrying a snowplow, the method comprising receiving ambient air from around a snowplow, regardless of a position and/or an orientation of the snowplow; and centrally directing the ambient air to a grill of the vehicle, the receiving and the directing being performed during a standard snow removal operation.

According to some embodiments of the invention, directing the ambient air comprises directing the ambient air over the entire area of the grill.

According to some embodiments of the invention, the method, further comprises changing the position and/or the orientation of the snowplow; and maintaining the receiving enough ambient air.

According to some embodiments of the invention, receiving comprises receiving without significantly interfering with vehicle headlights.

According to some embodiments of the invention, receiving comprises receiving enough ambient air, and directing comprises directing the air at a rate fast enough to maintain a proper temperature of the at least one engine component.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a top view of an air-scoop coupled to a vehicle carrying a snowplow, in accordance with an embodiment of the invention;

FIG. 2 is a front view of the air-scoop, in accordance with an embodiment of the invention;

FIGS. 3A-3B are schematic illustrations of a connector of the air-scoop, in accordance with an embodiment of the invention;

FIGS. 4A-4B are side views of a snowplow carrying vehicle with the snow plow in different positions and/or orientations, in accordance with an embodiment of the invention;

FIGS. 5A-5B are front and side views of an air-scoop, in accordance with another embodiment of the invention;

FIGS. 5C-5D are front and side views of the air scoop of FIGS. 5A-5B showing some exemplary dimensions;

FIG. 6 is a front view of an air-scoop, in accordance with another embodiment of the invention; and

FIG. 7 is a flow chart of a method of delivering ambient air to a region near a vehicle engine, in accordance with an embodiment of the invention.

### DESCRIPTION OF SPECIFIC EMBODIMENTS OF THE INVENTION

The present invention, in some embodiments thereof, relates to an air flow device and, more particularly, but not exclusively, to an air flow device for directing air flow around a snowplow into an engine.

An aspect of some embodiments of the invention relates to a device for directing ambient air from around a snowplow towards at least one engine component and/or engine compartment, without significantly interfering and/or restricting standard operation. Some not necessarily limiting examples of engine components include a radiator, an oil cooler, a transmission cooler and/or other mechanisms surrounding the radiator. Optionally, the device may be used to direct ambient air toward radiators and engines of different vehicles with different dimensions (e.g. width of the grill of about 50 cm, or about 75 cm, or about 100 cm, or about 150 cm, or other smaller, intermediate or larger sizes) and/or to be mounted on top of different types of snowplows with different dimensions (e.g. snowplow width of about 100 cm, or about 150 cm, or about 200 cm, or other smaller, intermediate or larger sizes). Optionally, directing the air does not significantly interfere with headlights. Additionally or alternatively, the device is structured to direct ambient air without significantly interfering with movement of the snowplow, for example, up, down, left, right, up tilt, down tilt, right tilt, left tilt, forward, and reverse. Additionally or alternatively, directing the air does not significantly interfere with movement of the vehicle carrying the snowplow. For example, forward, reverse, left turn, and right turn.

In exemplary embodiments of the invention, ambient air is directed from a lateral position to a central position, for example, through a network of tubes and connectors. Optionally, air is directed from left and/or right sides to a central location, for example, in front of a grill of a vehicle (engine components are housed behind the grill).

An aspect of some embodiments of the invention relates to supplying air at a level sufficient to cool the entire exposed surface of a radiator of the vehicle. Optionally, the supplied air is delivered to the entire surface area of the grill, for example, by a sufficiently large outlet. Optionally, one or more additional engine components are cooled, for example, an oil container and/or transmission cooler.

In exemplary embodiments of the invention, the opening area of the outlet is larger than the total opening area of inlets that accept the ambient air.

In exemplary embodiments of the invention, air is supplied to cool at least one engine component to maintain a safe engine operating temperature, for example, according to manufacturer specifications. Optionally, the safe temperature is maintained during standard snow cleaning procedures, for example, plowing snow, moving the removed snow, transporting the snowplow (without snow).

In exemplary embodiments of the invention, air is supplied at a level sufficient for combustion by the engine, potentially preventing over-heating and/or helping with proper engine operation.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

In some cases, snowplow vehicles are standard vehicles, for example, pick-up trucks, with a snowplow attached at the front. Generally, the snowplow is used during the winter season, and removed once snowfall has stopped, allowing other uses of the vehicle.

The Inventor discovered that since the standard vehicles are not specially designed for accommodating the snowplow, it is possible for the vehicle to be damaged by the plow. For example, the plow can form a barrier, reducing the amount of air reaching the radiator and/or other engine components, potentially leading to overheating and other operating problems. As described herein, the Inventor provides some possible devices and/or methods to provide enough air to cool one or more engine components during standard snowplowing procedures, for example, transporting the plow on the road, clearing the snow and/or moving the snow.

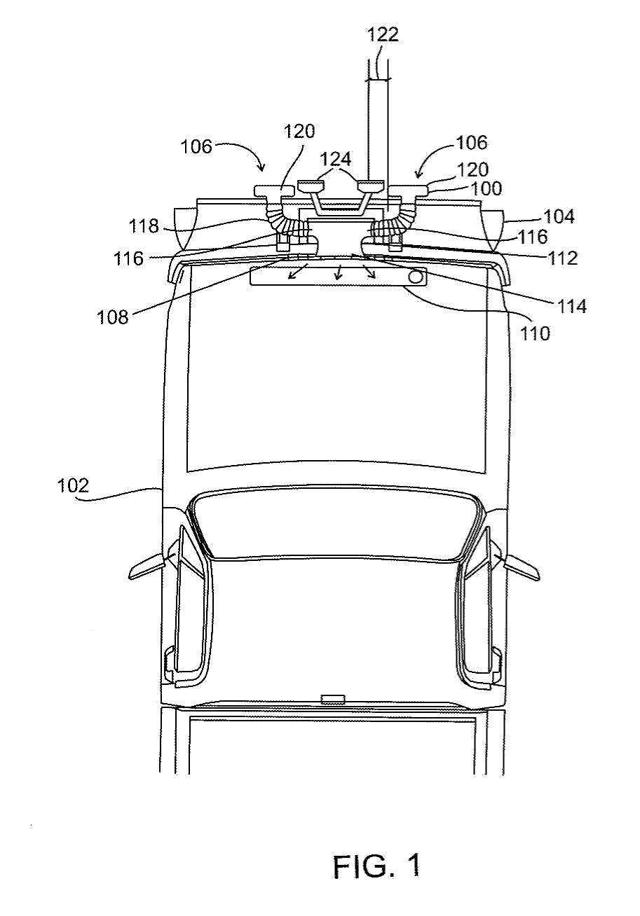

Referring now to the drawings, FIG. 1 is a top view of an air-scoop 100 coupled to a vehicle 102 carrying a snowplow 104, in accordance with an embodiment of the invention. As will be discussed in greater detail below, air-scoop 100 directs ambient air 106 (represented by arrows), from the region surrounding snowplow 104 and/or vehicle 102 to a region in near proximity to a vehicle grill 108. Air 106 travels through grill 108 to reach one or more engine components 110, for example a radiator, an oil container and/or a transmission cooler. Potentially, air-scoop 100 delivers enough air at a fast enough rate to maintain the temperature of the one or more engine components 110 within an acceptable range, potentially preventing or reducing overheating and/or damage. Potentially, as will be discussed in greater detail, air-scoop 100 delivers enough air to maintain the temperature, even during standard snow removal procedures.

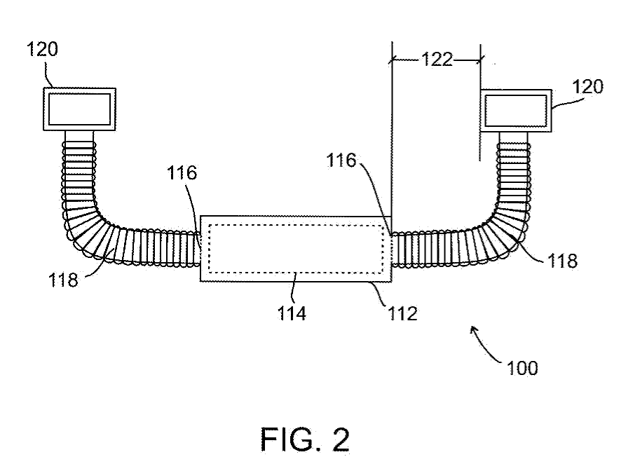

FIG. 2 is a front view of air-scoop 100 of FIG. 1. For clarity, air-scoop 100 is shown without the attachment to vehicle 102 and/or snowplow 104. In an exemplary embodiment of the invention, air-scoop 100 comprises of a connector 112, having a back opening 114. When connector 112 is positioned for use, back opening 114 is positioned in near proximity to, or touching grill 108. Optionally, connector 112 is coupled to vehicle 102 by one or more attachment methods and/or devices, for example, bolts, screws, clamps, and/or other suitable ways.

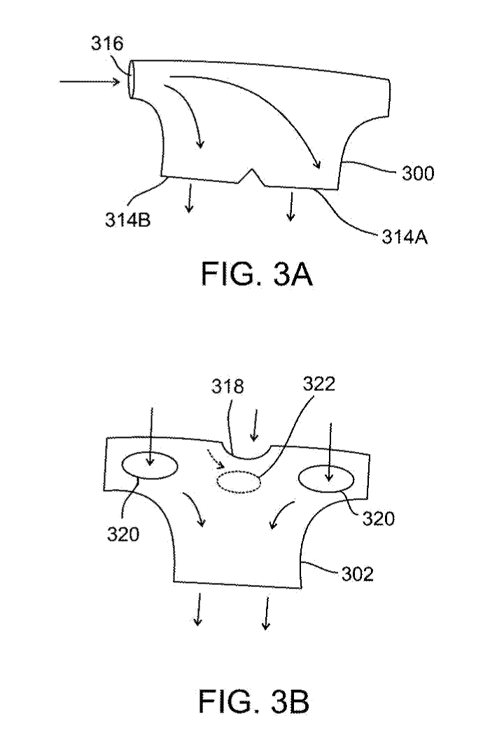

In exemplary embodiments of the invention, connector 112 is at least partially hollow, providing for air flow between back opening 114 and one or more side openings 116. Optionally, there are two side openings 116, optionally on opposite sides of connector 112. Additional possibilities will be described below with reference to FIGS. 3A-3B.

In an exemplary embodiment of the invention, a proximal end of conduit 118 is coupled to side opening 116. Optionally, an air inlet 120 is coupled to a distal end of conduit 118.

In exemplary embodiments of the invention, air-scoop 100 is arranged to have an overall ‘Y’ shape. Conduits 118 and/or air inlets 120 are the left and right branches of the ‘Y’. Connector 112 is the root of the ‘Y’, which connects the two branches together. Air flow is from the top of the ‘Y’, entering the two side branches, merging at the root and exiting from the bottom. Potentially, the ‘Y’ shape provides flexibility for use with different vehicles. For example, the ‘Y’ allows headlights to be positioned between the arms of the ‘Y’, reducing or preventing interference with the light. Alternatively, other shapes are possible, for example, ‘U’, ‘T’, or other arrangements.

In exemplary embodiments of the invention, connector 112 is ‘Y’ shaped. The left and right arms of the ‘Y’ terminate in left and right side openings 116. The two arms join together forming the root of the ‘Y’, which terminates in back opening 114.

Optionally, air flows through optional air inlet 120, through conduit 118, into connector 114 through side opening 116, and out through back opening 114. The air exiting back opening 114 may then flow through grill 118 to cool one or more engine components 110. Optionally, air flow is passive, for example, flowing as a result of movement of vehicle 102, snowplow 104, ambient wind, temperature gradients between the ambient air and/or engine components 110. Alternatively or additionally, air flow is active, for example, a fan within air-scoop 100 moves the air.

Optionally, air inlet 120 (or distal end of conduit 118) is laterally displaced relative to back opening 114, as illustrated by a displacement distance 122 of, for example, at least 10 cm, at least 20 cm, at least 30 cm, at least 30 cm, at least 50 cm, or other intermediate or larger distances are used. Distance 122 is measured along a horizontal axis when vehicle 102 is viewed from the front, also referred to herein as a “short axis”.

Optionally, distance 122 is large enough so that conduit 118 and/or air inlet 120 leave sufficient room for headlights 124 to be located therein, so that objects in front of the vehicle are properly illuminated. For example, conduit 118 and/or air inlet 120 are not positioned in the area in front of headlights 124. For example, headlights 124 are disposed between air inlet 120.

Optionally, at least a section of conduit 118, or the entire conduit 118 is made out of a flexible material able to accommodate changes in position and/or orientation. For example, the conduit section is able to accommodate, without breaking, a bending angle therein of about 10-180 degrees, or about 30-120 degrees, or about 45-90 degrees, or other smaller, intermediate or larger ranges. Optionally, the material is designed for flexibility, for example, a corrugated arrangement. Alternatively or additionally, the material itself is flexible, for example, rubber.

Optionally, conduit 118 is at least partially made of a resilient material that returns to an initial position and/or orientation. For example, spring and/or rubber.

Alternatively, in some embodiments, conduit 118 maintains the new position, for example, not being made out of a resilient material.

Optionally, one or more parts of air-scoop 100 are made of suitable materials, for example, steel in a stamping process with minor metal finishing, plastic, and/or fiberglass. Optionally, after manufacturing, a suitable anti-corrosion finish is used, for example, paint. Optionally, the manufacturing process is adaptable for large scale production.

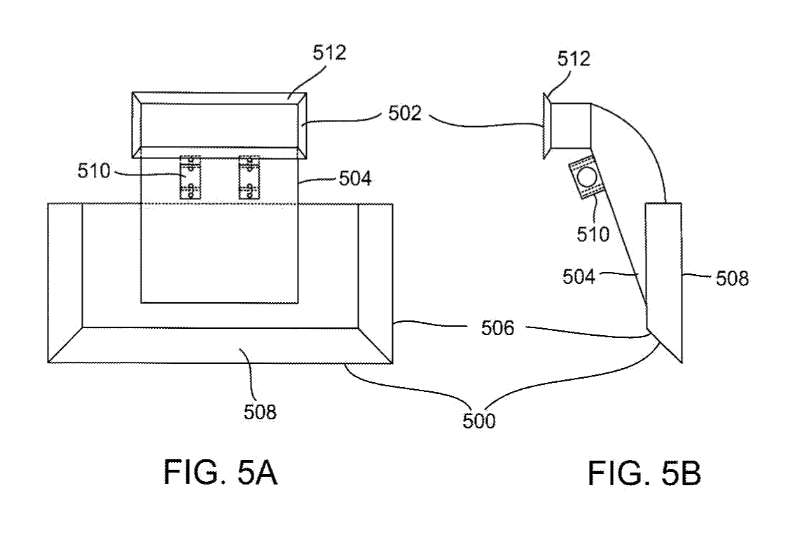

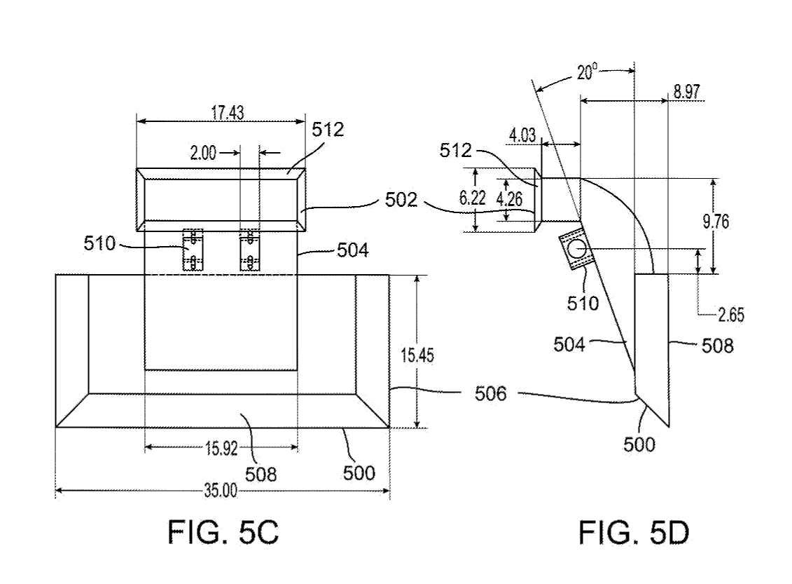

Optionally, the total intake area of one or more air inlets 120 is large enough to provide enough air at a rate sufficient to cool one or more engine components 110 and/or to maintain the temperature of components 110 within a safe range. For example, for a rectangular shaped inlet (although it is understood that other shapes may be used), the dimensions are about 15×30 cm, or about 30×30 cm, or about 15×15 cm, or about 10×15 cm, or about 10×45 cm, or about 15×45 cm, or other smaller, intermediate or larger dimensions. Optionally, the area of back opening 114 is large enough to allow the collected air to flow out to cool the radiator. In some embodiments, the area of back opening 114 is large enough to allow the collected air to cool other engine components in addition to the radiator. Details of the size of the outflow opening will be discussed with reference to FIGS. 5A-5B.

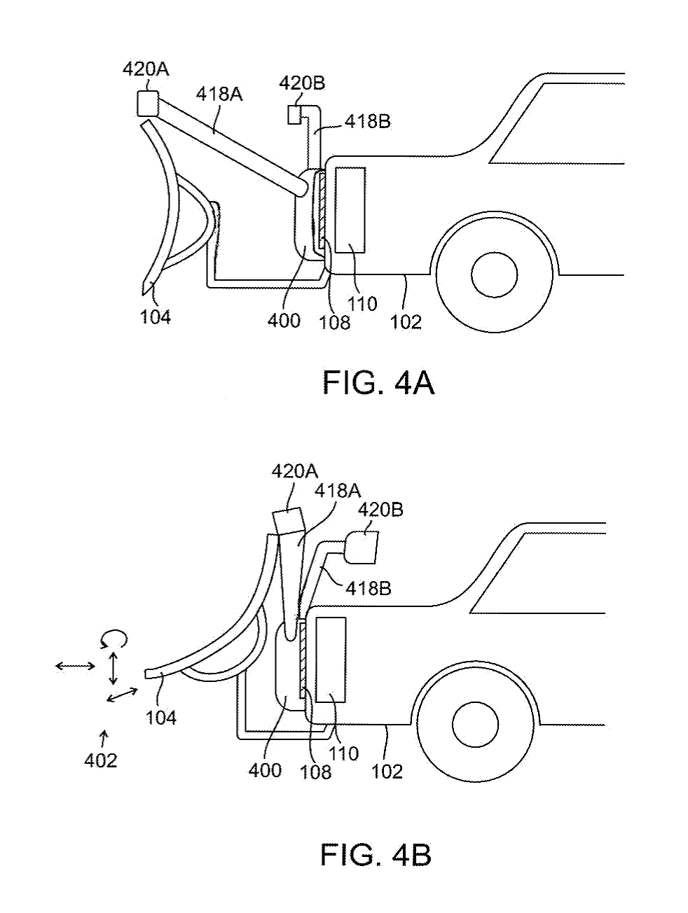

Optionally, air inlets 120 are positioned above snowplow 104. Optionally, air inlets 120 are forward facing. Some other examples of possible locations for inlets 120 will be described with reference to FIGS. 4A-4B.

FIGS. 3A-3B are some examples of possible air-scoop connectors designs, in accordance with some embodiments of the invention. Connectors are shown from a top view. Arrows represent the direction of airflow through the connectors. Different connectors may be used, for example, to accommodate different design and/or locations of vehicles and/or snow plows.

FIG. 3A is a connector 300 having two back openings 314A and 314B for placement in proximity to one or more engine components. Potentially, such a design may be used for vehicles, for example, with a ‘V’ shaped front, having grills on both sides of the ‘V’. In some embodiments, back openings 314A-B are also ‘V’ shaped to fit the vehicle. Alternatively, other numbers of back openings are possible, for example, 3, 4 or more back openings. Alternatively, there is one back opening, as previously shown, for example, in FIG. 1.

Also shown in FIG. 3A, connector 300 comprises a single side opening 316 for attachment to a conduit, disposed on the left (as shown) or right side of connector 300, in accordance with some embodiments. Potentially, the single side opening 316 may be used, for example, on vehicles having snowplows that are not symmetrically attached, for example, vehicles used to clean streets that have side tilted snowplows, with one side closer to the front of the vehicle and the opposite side further from the vehicle. In such a case, there may not be enough room for a conduit to attach to the connector on the one side with the tilted plow.

FIG. 3B is a schematic of a connector 302 having one or more front openings 318, one or more top openings 320, and/or one or more bottom openings 322, in accordance with some embodiments of the invention. In some embodiments, connector 302 does not have side openings. The selection of the location of the openings may be based on, for example, the shape of the snowplow and/or the size of the engine. For example, a ‘V’ snow plow might restrict space on the side of connector 302, but allow room for conduits to attach to the front or the top of connector 302.

FIGS. 4A-4B are a side view of vehicle 102 (of FIG. 1) with an air-scoop 400 under different positions and/or orientations of snowplow 104, in accordance with some embodiments of the invention. Although two conduits and air vents are shown, it should be understood that this is for illustrative purposes only, and other numbers of conduits and/or air vents may be used.

As shown in FIG. 4A, in some embodiments, conduits 418A and 418B have different positions, for example, one closer to the front of vehicle 102 and one further from vehicle 102. Potentially, different positions of conduits 418A and 418B may be used to accommodate an asymmetrically positioned snowplow 104. Alternatively, conduits 418A-B are approximately symmetrically positioned.

In some embodiments, conduit 418A is coupled to snowplow 104, for example, to the top or side. Some examples of coupling methods include rivets, bolts, screws, gravity (setting the conduit on top of the plow) and/or grabbers. In some embodiments, conduit 418B is set in space without an attachment to snowplow 104, for example, conduit 418B is made out of a material rigid enough to maintain a position once set. The position of conduit 418B may be set manually (e.g., by a human operator) or automatically (e.g., using circuitry controlled by a human or by computer).

In some embodiments, air inlets 420A-B are forward facing (FIG. 4A). Alternatively, air inlets 420A-B may face in other directions, for example, up, down, left, right, backwards (FIG. 4B). Potentially, facing in a direction other than forward helps prevent or reduce snow from entering air inlets 420A-B. Potentially, one or more air inlets 420A-B face in the direction of the ambient wind and/or in the direction of travel, to help air enter air-scoop 400. Optionally, the direction of air inlet 420A-B is adjustable, for example, manually or automatically. Alternatively, the direction of air inlet 420A-B is not changed.

FIG. 4A is an example of snowplow 104 in a first position, for example, during cleaning of snow or during transport on the road. FIG. 4B is an example of snowplow 104 in a second position, for example, during carrying of snow. Other first and second positions are possible, as illustrated by direction arrows 402.

In some embodiments, a change in position of snowplow 104 results in changes in positions of conduits 418A-B and/or air inlets 420A-B. Position changes may occur, for example, by plow 104 moving an attached conduit 418A-B and/or inlet 420A-B, by plow 104 pushing or pulling adjacent conduits 418A-B and/or inlets 420A-B, manually by a human operator, and/or automatically by computer controlled circuitry and actuators.

A potential advantage of air-scoop 400 is the ability to accommodate different positions and/or orientations of plow 104 and/or different vehicle 102 types, thereby providing sufficient air flow to motor components 110 to maintain the temperature within the safe range.

FIG. 5A is a front view and FIG. 5B is a side view of another embodiment of an air-scoop 500, in accordance with another embodiment of the invention. Air-scoop 500 comprises a back opening 508 large enough to cover most or the entire area of a vehicle grill and/or the exposed area of one or more engine components. For example, the area of back opening 508 is at least 100% of the area of the grill, or at least 70%, or at least 80%, or at least 120%, or at least 150%, or at least 200%, or other smaller, intermediate or larger percentages. Potentially, the large sized back opening 508 provides a larger distribution of air, thereby cooling the engine components to the safe range and/or maintaining the safe range temperature.

Some examples of the dimensions of back opening 508 include about 50×100 cm, or about 30×45 cm, or about 15×30 cm, or other smaller, intermediate or larger dimensions.

Optionally, air-scoop 500 comprises an air inlet 502 coupled to a connector 506 through a conduit 504. Optionally, air inlet 502 comprises an outer rim 512, for example, to help direct air to the interior of inlet 502.

Optionally, the area of back opening 508 is larger than the area of air inlet 502, for example, about 50% larger, or about 200%, or about 400%, or about 700%, or about 1000%, or other smaller, intermediate or larger ratios.

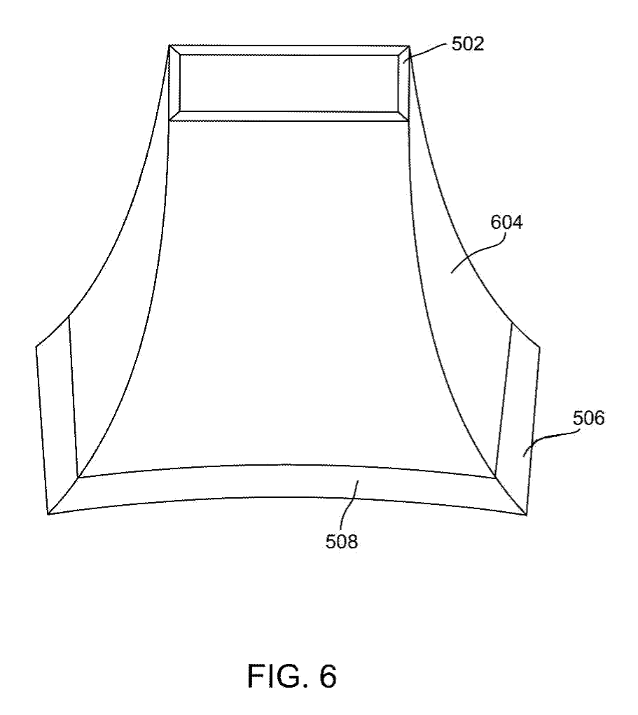

Optionally, the cross sectional area of conduit 504 is approximately similar to the opening of air inlet 502. Alternatively, as shown in FIG. 6, the cross sectional area of a conduit 604 may gradually increase, from an initial cross sectional area approximately equal to air inlet 502 to a final cross sectional area approximately equal to back opening 508.

FIGS. 5C and 5D correspond to FIGS. 5A and 5B, and illustrate some exemplary dimensions of air scoop 500. Note measurements are in inches.

Optionally, air-scoop 500 comprises an attachment element 510 for attaching to the snowplow, for example, clamping on to support brackets at the back of the plow.

Optionally, conduit 504 may change orientation and/or position relative to connector 508. Optionally, conduit 504 may tilt, for example, by a hinge. Alternatively, the tilt angle is rigidly set.

It should be noted that the air-scoop embodiment of FIG. 5A-B may be combined with other embodiments, for example, with the air-scoop embodiment of FIG. 1. For example, the air-scoop of FIG. 1 may have a large back opening.

Optionally, pieces of the air-scoop may be sold separately, allowing mix and match. For example, the pieces may be selected to fit the vehicle's dimension(s) and/or snowplow dimension(s).

For example, the air inlets are sold separately. Alternatively, the air inlets are sold already attached to the conduit. Optionally, different air inlets are available, for example, facing different directions and/or having different opening areas.

Optionally, the conduits are sold separately. For example, to replace worn out flexible conduits after heavy use. Optionally, different conduits are available, for example, flexible or non-flexible, resilient or rigid, having varying lengths and/or diameters.

Optionally, the connector is sold separately. Alternatively, the connector is sold attached to the conduits. Alternatively, the connector is sold attached to the conduits and the air inlets. Optionally, different connectors are available, for example, having different sized back opening areas and/or different openings to attach to the conduits.

In some embodiments, plugs are available to plug openings of the connector, for example, if the opening will not be used to attach a conduit.

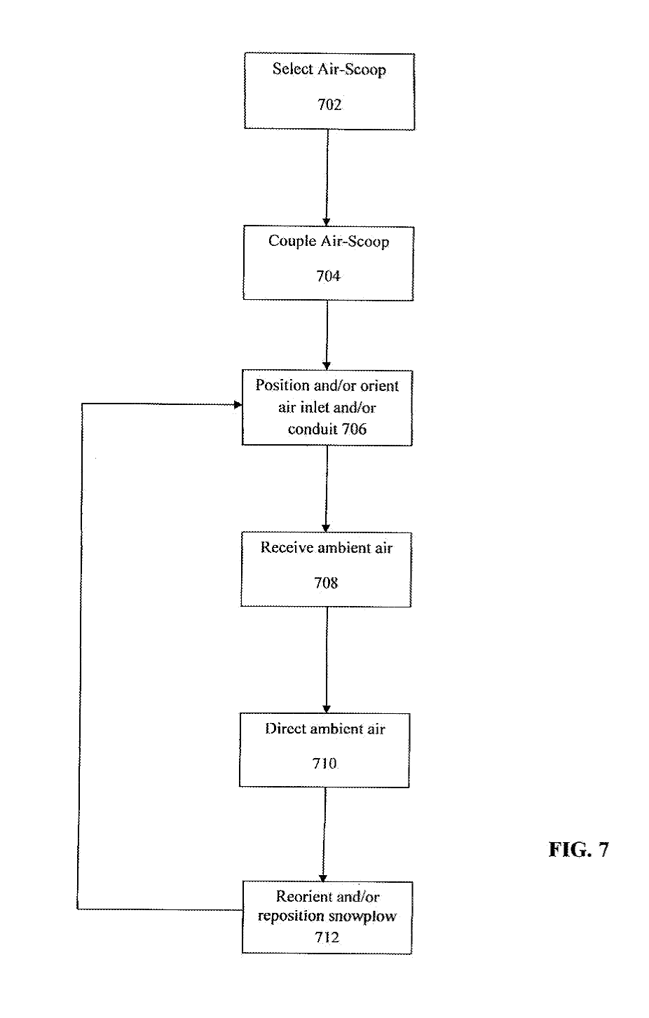

FIG. 7 is a flowchart of a method of delivering air to at least one engine component of a vehicle carrying a snowplow, in accordance with an exemplary embodiment of the invention. Potentially, the method allows for delivery of enough air to cool the engine components, regardless of the type and/or use of the snowplow and/or vehicle.

Optionally, at 702, the air-scoop type is selected. Optionally, as described above, the parts of the air-scoop are selected according to the vehicle and/or snowplow. For example, a large back opening is selected for a large engine. For example, flexible conduits are selected to accommodate wide movements of the snowplow and/or to accommodate headlights.

Optionally, at 704, the air-scoop is coupled to the vehicle, for example, attached in near proximity to the grill so that the back opening faces the grill. Alternatively or additionally, the air-scoop is coupled to the snowplow.

Optionally, at 706, the air inlets and/or conduits are positioned and/or oriented. Optionally, the position and/or orientation are selected according to the specific vehicle in use and/or so as not to interfere with snow removal functions. For example, the conduits are bent around headlights, and/or the air inlets are positioned above the snowplow and/or air inlets are positioned facing backwards.

At 708, ambient air is received from a region around the snowplow. Optionally, the amount of ambient air received is sufficient to cool and/or maintain a temperature of the at least one engine component within a safe range.

At 710, the ambient air is directed to a region in near proximity to one or more engine components, for example, near the vehicle grill. Optionally, the ambient air is directed from a relative lateral position to a relatively central position. Additionally or alternatively, the ambient air is accepted at a relatively small intake area and released from a relatively larger outlet area. Optionally, the ambient air is directed at least over the entire area of the grill and/or one or more engine components.

Optionally, at 712, the snowplow is re-oriented and/or repositioned, for example, by the human operator as part of the snow removal procedure.

Optionally, the changing snowplow results in changes to the position and/or orientation of the air inlets and/or conduits, as in 706. Optionally, even though the snowplow has moved, the ambient air is still received and directed to the one or more engine components as in 708 and 710.

It is expected that during the life of a patent maturing from this application many relevant air-scoops will be developed and the scope of the term air-scoop is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A device for directing air flow to at least one engine component of a vehicle carrying a snowplow, the device comprising:
at least one air inlet;
at least one conduit, the conduit in fluid communication with the at least one air inlet; and
a connector having at least a first opening in fluid communication with the at least one conduit, the connector having a second opening adapted for fluid communication with the at least one engine component to allow air flow from the at least one air inlet to reach the at least one engine component, the at least one air inlet and the second opening being laterally displaced relative to each other along a short axis of the vehicle.

2. A device according to claim 1, wherein said device comprises at least two air inlets and the connector respectively comprises at least two first openings.

3. A device according to claim 2, wherein said device is arranged as a ‘Y’, the connector forming the root of the ‘Y’, and the left and right conduits forming the arms of the ‘Y’.

4. A device according to claim 1, wherein at least a portion of the at least one conduit is made out of a flexible material so that the portion can accommodate changes in position and/or orientation.

5. A device according to claim 4, wherein the portion is corrugated.

6. A device according to claim 2, wherein said two air inlets are spaced apart enough so as not to significantly interfere with headlights on the vehicle, the headlights being located between the two air inlets.

7. A device according to claim 1, wherein said laterally displaced comprises a distance of at least about 30 centimeters.

8. A device according to claim 1, wherein a total opening area of the air inlets is large enough to provide enough air to the at least one engine component to cool the at least one engine component under standard snow removal operation.

9. A device according to claim 1, wherein the connector is positioned in front of a grill of the vehicle and the air inlets are positioned above the snowplow.

10. A device according to claim 1, wherein the second opening is large enough to cover the entire area of a grill of the vehicle.

11. A snow removal system comprising:
a device for directing air flow according to claim 1;
a snowplow; and
a vehicle having at least one engine component, the snowplow being coupled to the vehicle for snow removal, and the device for directing air flow is coupled to the vehicle so that the device directs air to the at least one engine component.

12. A device for directing air flow to at least one engine component of a vehicle carrying a snowplow, the device comprising:
at least one air inlet;
at least one conduit, the conduit in fluid communication with the at least one air inlet; and
a connector having at least a first opening in fluid communication with the at least one conduit, the connector also having a second opening adapted for fluid communication with the at least one engine component to allow air flow from the at least one air inlet to reach the at least one engine component, the opening area of the second opening being larger than the opening area of the at least one air inlet.

13. A device according to claim 12, wherein said larger comprises at least 50% larger.

14. A device according to claim 12, wherein the opening area of the second opening is large enough to cover an entire grill area of the vehicle.

15. A device according to claim 12, wherein a portion of the at least one conduit is constructed so that the at least one air inlet can tilt relative to the connector.

16. A method of delivering air to at least one engine component of a vehicle carrying a snowplow, the method comprising:
receiving ambient air from around a snowplow, regardless of a position and/or an orientation of the snowplow; and
centrally directing the ambient air to a grill of the vehicle, the receiving and the directing being performed during a standard snow removal operation.

17. A method according to claim 16, wherein directing the ambient air comprises directing the ambient air over the entire area of the grill.

18. A method according to claim 16, further comprising:
changing the position and/or the orientation of the snowplow; and
maintaining the receiving enough ambient air.

19. A method according to claim 16, wherein receiving comprises receiving without significantly interfering with vehicle headlights.

20. A method according to claim 16, wherein receiving comprises receiving enough ambient air, and directing comprises directing the air at a rate fast enough to maintain a proper temperature of the at least one engine component.
